(19) United States
(12) Patent Application Publication
(10) Pub. No.: US 2021/0377197 A1
(43) Pub. Date: Dec. 2, 2021

(54) A MAIL TRANSMISSION METHOD, SERVER AND SYSTEM

(71) Applicant: WANGSU SCIENCE & TECHNOLOGY CO., LTD., Shanghai (CN)

(72) Inventors: Sichen LIN, Shanghai (CN); Yuxian HUANG, Shanghai (CN); Zhiquan ZENG, Shanghai (CN)

(21) Appl. No.: 16/317,913

(22) PCT Filed: Jun. 14, 2018
(86) PCT No.: PCT/CN2018/091214

§ 371 Date: Jan. 15, 2019

(30) Foreign Application Priority Data
May 10, 2018 (CN) 201810442232.0

(51) Int. Cl. H04L 12/58; H04L 29/08

(52) U.S. Cl. CPC H04L 51/066; H04L 67/06; H04L 51/26; H04L 51/22

(57) ABSTRACT

A mail transmission method includes: performing, by the first node, a fragmentation process on the mail data to obtain a plurality of data fragments; and for each data fragment, based on historically transmitted mail data, determining, by the first node, whether the data fragment is a data fragment that has been previously transmitted, when the data fragment is a data fragment that has not been previously transmitted, transmitting, by the first node, the data fragment to the second node, and when the data fragment is a data fragment that has been previously transmitted, transmitting, by the first node, a feature value of the data fragment to the second node, where the feature value is used to instruct the second node to acquire the data fragment.

### FIELD OF DISCLOSURE

The present disclosure generally relates to the field of network communication technology and, more particularly, relates to a mail transmission method, a server, and a system thereof.

### BACKGROUND

E-mail is a common means of information exchange in an information-based society. For example, in most companies, one of the most important means of communication is e-mail.

However, in certain application scenarios, there are a large number of situations, such as internal corporate notification, and document delivery, in which emails with the same or similar content are repeatedly transmitted. Emails with the same or similar content may seriously waste the resource of a mail transmission system and affect the mail transmission efficiency.

### BRIEF SUMMARY OF THE DISCLOSURE

The present disclosure provides a mail transmission method, a server and a system thereof, for improving the mail transmission efficiency.

In a first aspect, the embodiments of the present disclosure provide a mail transmission method for application in a mail transmission system including a first node and a second node, where the first node is configured to receive mail data transmitted by a transmitting terminal, and the second node is configured to transmit the mail data to a receiving terminal. The method includes:

performing, by the first node, a fragmentation process on the mail data to obtain a plurality of data fragments; and

for each data fragment,

based on historically transmitted mail data, determining, by the first node, whether the data fragment is a data fragment that has been previously transmitted;

when the data fragment is a data fragment that has not been previously transmitted, transmitting, by the first node, the data fragment to the second node; and

when the data fragment is a data fragment that has been previously transmitted, transmitting, by the first node, a feature value of the data fragment to the second node, where the feature value is used to instruct the second node to acquire the data fragment.

In the above-described solution, the first node fragments the mail data, and determines, based on the historically transmitted mail data, whether the data fragment is a data fragment that has been previously transmitted. When the data fragment is a data fragment that has been previously transmitted, the first node only transmits the feature value of the data fragment. The second node that transmits the mail data to the receiving terminal may acquire the data fragment according to the feature value, thereby reducing the amount of data transmitted between the first node and the second node, saving the consumption of the resource of the mail transmission system, and thus improving the mail transmission efficiency.

Optionally, when the data fragment is a data fragment that has not been previously transmitted, the method further includes:

caching, by the first node, the data fragment and the feature value of the data fragment in a local cache of the first node; and

determining, by the first node, based on the historically transmitted mail data, whether the data fragment is a data fragment that has been previously transmitted includes:

acquiring the feature value of the data fragment;

querying the local cache of the first node according to the feature value of the data fragment;

when the feature value of the data fragment exists in the local cache of the first node, determining that the data fragment is a data fragment that has been previously transmitted; and

when the feature value of the data fragment does not exist in the local cache of the first node, determining that the data fragment is a data fragment that has not been previously transmitted.

In the above-described solution, when a data fragment is a data fragment that has not been previously transmitted, the first node stores the data fragment and the feature value of the data fragment in the local cache of the first node. Therefore, the first node may determine whether the data fragment is a data fragment that has been previously transmitted by querying the local cache. Since the feature value may be directly calculated based on the data fragment, and may uniquely identify the data fragment, the first node may query the local cache by using the feature value to determine whether the data fragmented has been previously transmitted.

Optionally, before performing, by the first node, the fragmentation process on the mail data, the method further includes:

parsing the mail data to determine body data of the mail data; and

performing the fragmentation process on the mail data includes:

performing the fragmentation process on the body data of the mail data.

In the above-described solution, mails with the same or similar content are mostly determined by the degree of repetition of the content of the mail body, while other data, such as mail headers, may be different. Therefore, only the body of a mail may need to be fragmented, thereby simplifying the fragmentation process and reducing the processing load on the first node.

Optionally, after transmitting the feature value of the data fragment to the second node, the method further includes:

receiving, by the first node, a miss response sent by the second node, where the miss response is sent to the first node by the second node when a data fragment corresponding to the feature value is not acquired from a local cache of the second node, and the miss response includes the feature value;

determining, by the first node, the data fragment corresponding to the feature value based on the feature value included in the miss response; and

transmitting, by the first node, the data fragment corresponding to the feature value to the second node.

In the above-described solution, although the data fragment is a data fragment that has been previously transmitted, it may be not transmitted to the second node. Therefore, after receiving the feature value, the second node may not be able to acquire the data fragment corresponding to the feature value from the local cache of the second node. At this point, the second node may send a miss response to the first node. After receiving the miss response, the first node re-transmits the data fragment to the second node, to allow the second node to acquire the data fragment.

Optionally, transmitting the data fragment to the second node includes:

transmitting a first data packet to the second node, where the first data packet includes the data fragment, the feature value of the data fragment, and a fragment serial number of the data fragment, the fragment serial number being used to denote a sequential number of a data fragment corresponding to the fragment serial number in the mail data; and

transmitting the feature value of the data fragment to the second node includes:

transmitting a second data packet to the second node, where the second data packet includes the feature value of the data fragment and the fragment serial number of the data fragment.

By adopting the above-described solution, the first data packet and the second data packet transmitted by the first node to the second node also include a fragment serial number corresponding to the data fragment. This allows the second node to determine an order of the data fragment in the mail data according to the fragment serial number, and thus to combine a plurality of data fragments into the mail data and transmit the mail data to the receiving terminal.

In a second aspect, the embodiments of the present disclosure provide a mail transmission method for application in a mail transmission system including a first node and a second node, where the first node is configured to receive mail data transmitted by a transmitting terminal, and the second node is configured to transmit the mail data to a receiving terminal. The method includes:

receiving, by the second node, a data fragment of the mail data transmitted by the first node, where the data fragment is transmitted after the first node performs a fragmentation process on the mail data and when it is determined, based on historically transmitted mail data, that the data fragment is a data fragment that has not been previously transmitted; and/or

receiving, by the second node, a feature value of the data fragment of the mail data transmitted by the first node, where the feature value is transmitted after the first node performs the fragmentation process on the mail data and when it is determined, based on the historically transmitted mail data, that the data fragment is a data fragment that has been previously transmitted;

generating, by the second node, the mail data based on each received data fragment and/or each received feature value; and

transmitting, by the second node, the generated mail data to the receiving terminal.

Optionally, receiving, by the second node, the data fragment of the mail data transmitted by the first node includes:

receiving, by the second node, a first data packet transmitted by the first node, where the first data packet includes the data fragment and the feature value of the data fragment;

storing, by the second node, the data fragment and the feature value of the data fragment in a local cache of the second node; and

after receiving, by the second node, the feature value of the data fragment of the mail data transmitted by the first node, the method further includes:

querying, by the second node, the local cache of the second node based on the feature value; and

when a data fragment corresponding to the feature value exists in the local cache of the second node, acquiring, by the second node, the data fragment corresponding to the feature value.

Optionally, the method further includes:

when the data fragment corresponding to the feature value does not exist in the local cache of the second node, sending, by the second node, a miss response to the first node, where the miss response includes the feature value, and the miss response is used to instruct the first node to transmit the feature value and the data fragment corresponding to the feature value to the second node.

Optionally, receiving, by the second node, the feature value of the data fragment of the mail data transmitted by the first node includes:

receiving, by the second node, a second data packet transmitted by the first node, where the second data packet includes the feature value of the data fragment and a fragment serial number of the data fragment, the fragment serial number being used to denote a sequential number of a data fragment corresponding to the fragment serial number in the mail data, and the fragment serial number of the data fragment being also included in the first data packet; and

generating, by the second node, the mail data based on each received data fragment and/or each received feature value includes:

acquiring, by the second node, each data fragment based on first data packets and/or second data packets; and

combining, by the second node, each data fragment into the mail data based on fragment serial numbers.

In a third aspect, the embodiments of the present disclosure provide a node server for application in a mail transmission system including a first node and a second node, where the first node is configured to receive mail data transmitted by a transmitting terminal, the second node is configured to transmit the mail data to a receiving terminal, the node server is coupled to the first node, and the node server includes a processing unit and a transceiving unit, where:

the processing unit is configured to perform a fragmentation process on the mail data to obtain a plurality of data fragments, and for each data fragment: determine, based on historically transmitted mail data, whether the data fragment is a data fragment that has been previously transmitted, when the data fragment is a data fragment that has not been previously transmitted, transmit, through the transceiving unit, the data fragment to the second node, and when the data fragment is a data fragment that has been previously transmitted, transmit, through the transceiving unit, a feature value of the data fragment to the second node, where the feature value is used to instruct the second node to acquire the data fragment.

Optionally, the processing unit is further configured to:

cache the data fragment and the feature value of the data fragment in a local cache of the first node; and

the processing unit is configured to:

acquire the feature value of the data fragment;

query the local cache of the first node according to the feature value of the data fragment;

when the feature value of the data fragment exists in the local cache of the first node, determine that the data fragment is a data fragment that has been previously transmitted;

and

when the feature value of the data fragment does not exist in the local cache of the first node, determine that the data fragment is a data fragment that has not been previously transmitted.

Optionally, the processing unit is further configured to:

parse the mail data to determine body data of the mail data; and

the processing unit is configured to:

perform the fragmentation process on the body data of the mail data.

Optionally, the transceiving unit is further configured to:

receive a miss response sent by the second node, where the miss response is sent by the second node when a data fragment corresponding to the feature value is not acquired from a local cache of the second node, and the miss response includes the feature value; and

the processing unit is further configured to:

determine the data fragment corresponding to the feature value based on the feature value included in the miss response, and transmit, through the transceiving unit, the data fragment corresponding to the feature value to the second node.

Optionally, the processing unit is configured to:

transmit, through the transceiving unit, a first data packet to the second node, where the first data packet includes the data fragment, the feature value of the data fragment, and a fragment serial number of the data fragment, the fragment serial number being used to denote a sequential number of a data fragment corresponding to the fragment serial number in the mail data; and

transmit, through the transceiving unit, a second data packet to the second node, where the second data packet includes the feature value of the data fragment and the fragment serial number of the data fragment.

In a fourth aspect, the embodiments of the present disclosure provide a node server for application in a mail transmission system including a first node and a second node, where the first node is configured to receive mail data transmitted by a transmitting terminal, the second node is configured to transmit the mail data to a receiving terminal, the node server is coupled to the second node, and the node server includes a processing unit and a transceiving unit, where:

the transceiving unit is configured to receive a data fragment of the mail data transmitted by the first node, where the data fragment is transmitted after the first node performs a fragmentation process on the mail data and when it is determined, based on historically transmitted mail data, that the data fragment is a data fragment that has not been previously transmitted; and/or

receive a feature value of the data fragment of the mail data transmitted by the first node, where the feature value is transmitted after the first node performs the fragmentation process on the mail data and when it is determined, based on the historically transmitted mail data, that the data fragment is a data fragment that has been previously transmitted; and

the processing unit is configured to generate the mail data based on each received data fragment and/or each received feature value, and transmit, through the transceiving unit, the generated mail data to the receiving terminal.

Optionally, the transceiving unit is configured to:

receive a first data packet transmitted by the first node, where the first data packet includes the data fragment and the feature value of the data fragment;

the processing unit is configured to:

store the data fragment and the feature value of the data fragment in a local cache of the second node; and

the processing unit is further configured to:

query the local cache of the second node based on the feature value, and when a data fragment corresponding to the feature value exists in the local cache of the second node, acquire the data fragment corresponding to the feature value.

Optionally, the processing unit is further configured to:

when the data fragment corresponding to the feature value does not exist in the local cache of the second node, send a miss response to the first node, where the miss response includes the feature value, and the miss response is used to instruct the first node to transmit the feature value and the data fragment corresponding to the feature value.

Optionally, the transceiving unit is configured to:

receive a second data packet transmitted by the first node, where the second data packet includes the feature value of the data fragment and a fragment serial number of the data fragment, the fragment serial number being used to denote a sequential number of a data fragment corresponding to the fragment serial number in the mail data, and the fragment serial number of the data fragment being also included in the first data packet; and

the processing unit is configured to:

acquire each data fragment based on first data packets and/or second data packets; and combine each data fragment into the mail data based on fragment serial numbers.

In a fifth aspect, the embodiments of the present disclosure provide a mail transmission system that includes any node server described in the third aspect and in the fourth aspect.

In a sixth aspect, the embodiments of the present disclosure provide a computer-readable storage medium. The computer-readable storage medium stores computer-executable instructions that cause a computer to implement any method described in the first aspect and/or any method described in the second aspect.

In a seventh aspect, the embodiments of the present disclosure provide a computer device that includes:

a memory for storing programming instructions; and

a processor for retrieving the programming instructions stored in the memory and implementing, according to the retrieved programming instructions, any method described in the first aspect and/or any method described in the second aspect.

### BRIEF DESCRIPTION OF THE DRAWINGS

To make the technical solutions in the embodiments of the present disclosure clearer, a brief introduction of the accompanying drawings consistent with descriptions of the embodiments will be provided hereinafter. It is to be understood that the following described drawings are merely some embodiments of the present disclosure. Based on the accompanying drawings and without creative efforts, persons of ordinary skill in the art may derive other drawings.

FIG. 1 is a mail transmission system according to some embodiments of the present disclosure;

FIG. 2 is a flowchart of a mail transmission method according to some embodiments of the present disclosure;

FIG. 3 is a schematic structural diagram of a practical mail transmission system according to some embodiments of the present disclosure;

FIG. 4 is a schematic diagram of a mail transmission process according to some embodiments of the present disclosure;

FIG. 5 is a schematic diagram of a practical mail transmission process in a first node server according to some embodiments of the present disclosure;

FIG. 6 is a schematic diagram of a practical mail transmission process in a second node server according to some embodiments of the present disclosure;

FIG. 7 is a schematic structural diagram of a node server according to some embodiments of the present disclosure;

FIG. 8 is a schematic structural diagram of another node server according to some embodiments of the present disclosure; and

FIG. 9 is a schematic structural diagram of another node server according to some embodiments of the present disclosure.

### DETAILED DESCRIPTION

To make the objective, technical solutions, and advantages of the present disclosure clearer, the present disclosure will be made in detail hereinafter with reference to the accompanying drawings. It is to be understood that the described embodiments are merely partial, but not exhaustive of the embodiments of the present disclosure. Based on the embodiments of the present disclosure and without creative efforts, a person skilled in the art may derive other embodiments, which shall fall within the scope of protection of the present disclosure.

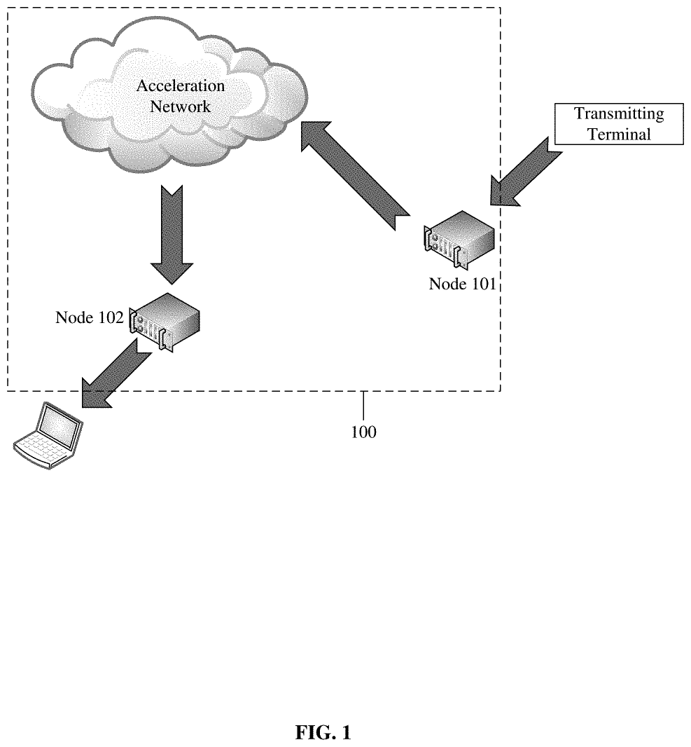

FIG. 1 is a mail transmission system according to some embodiments of the present disclosure. As shown in FIG. 1, the mail transmission system 100 includes a first node 101 and a second node 102, where the first node 101 is configured to receive mail data transmitted by a transmitting terminal, and the second node 102 is configured to transmit the mail data to a receiving terminal. The first node 101 and the second node 102 are connected by a network. In a specific implementation process, the first node 101 and the second node 102 may be nodes in an acceleration network, such as an APPA® acceleration network of Wangsu Science & Technology Co., Ltd. In the APPA® acceleration network, the nodes are distributed across various regions of the world. The system may be divided into a near-terminal and an away-terminal. The near-terminal refers to an APPA® node that is adjacent to a transmitting terminal, that is, the first node 101 in the embodiments of the present disclosure. The away-terminal refers to an APPA® node that is adjacent to a receiving terminal, that is, the second node 102 in the embodiments of the present disclosure. It is to be understood that the transmitting terminal and the receiving terminal may be switched. Accordingly, for any node, it may be switched between the first node 101 and the second node 102. For instance, in the process of transmitting a mail from a mail server to a user terminal, in which the transmitting terminal is the mail server and the receiving terminal is the user terminal, the first node 101 is a node that is adjacent to the mail server, while the second node 102 is a node that is adjacent to the user terminal. In the process of uploading mail data by a user terminal to a mail server, in which the transmitting terminal is the user terminal and the receiving terminal is the mail server, the first node 101 is a node that is adjacent to the user terminal, while the second node 102 is a node that is adjacent to the mail server.

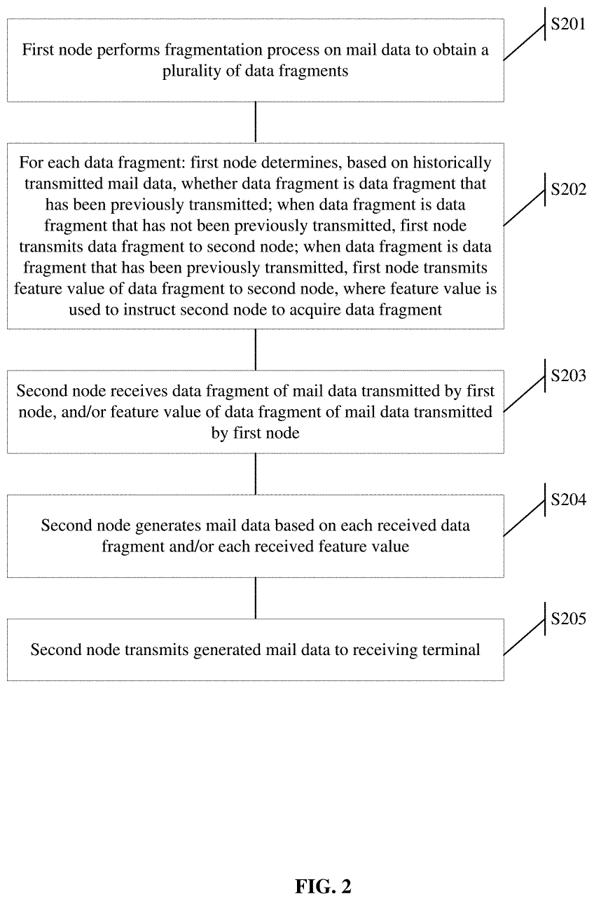

Based on the mail transmission system shown in FIG. 1, the embodiments of the present disclosure provide a mail transmission method. FIG. 2 is a flowchart of a mail transmission method according to some embodiments of the present disclosure. As shown in FIG. 2, the method mainly includes the following steps:

S201: the first node performs a fragmentation process on the mail data to obtain a plurality of data fragments.

S202: for each data fragment, the first node determines, according to historically transmitted mail data, whether the data fragment is a data fragment that has been previously transmitted; when the data fragment is a data fragment that has not been previously transmitted, the first node transmits the data fragment to the second node; when the data fragment is a data fragment that has been previously transmitted, the first node transmits a feature value of the data fragment to the second node, where the feature value is used to instruct the second node to acquire the data fragment.

S203: the second node receives the data fragment of the mail data transmitted by the first node, and/or the feature value of the data fragment of the mail data transmitted by the first node.

S204: the second node generates the mail data according to each received data fragment and/or each received feature value.

S205: the second node transmits the generated mail data to the receiving terminal.

In S201, the mail data in the first node is provided to the first node by the transmitting terminal. In a specific implementation process, the size of a data fragment may be determined according to the actual working environment of a mail system. The smaller the data fragment, the easier it is to hit, but the more the system resource of the first node to be consumed. Conversely, the larger the data fragment, the harder it is to hit, but the less the system resource of the first node to be consumed. Optionally, the first node may fragment the mail data according to certain rule(s), so that when the mail data and the historically transmitted mail data have different initial parts, fragmentation of the mail data to a certain number may allow a countermeasure to be achieved and the subsequent data fragments to be aligned, that is, the subsequent data fragments of the mail data to be consistent with the data fragments of the historically transmitted mail data. Similarly, if it happens that a middle part of the mail data is not consistent with the historically transmitted mail data, as long as there is enough remaining data, the subsequent data fragments may still be aligned.

Optionally, before performing the fragmentation process on the mail data, the first node further parses the mail data, and determines body data of the mail data; and performing the fragmentation process on the mail data includes performing the fragmentation process on the body data of the mail data. It is to be understood that the body data in the present disclosure includes attachment data in a mail. The same or similar mails mainly refer to the repetition of the body data of the mails. Other data, such as mail headers, may be different. Therefore, only the body of a mail may need to be fragmented, while other data may be processed according to the existing technologies.

In S202, the first node compares each data fragment with the historically transmitted mail data to determine whether the data fragment is a data fragment that has been previously transmitted. It should be understood that the historically transmitted mail data refers to the mail data that has been previously transmitted by the mail transmission system. For the first node, the historically transmitted mail data includes the mail data that has been previously transmitted by the first node, and also includes the mail data that has been previously received by the first node. In a specific implementation process, the first node may first break the mail data into a plurality of data fragments, and then compare each data fragment with the historically transmitted mail data; or each time a data fragment is obtained, the data fragment is compared right away with the historically transmitted mail data, and so on.

In a practical implementation, the historically transmitted mail data is cached in the local cache of the first node in the form of data fragments. In the local cache of the first node, each data fragment has a corresponding feature value. For any one data fragment of a to-be-transmitted mail data, the feature value of the data fragment is calculated, and then the local cache of the first node is queried according to the feature value to determine whether the data fragment is a data fragment that has been previously transmitted. It should be understood that, in the disclosed implementation, the local cache of the first node may have not necessarily saved all mail data, but have only saved the data fragments and their corresponding feature values for the mail data that has been previously transmitted. In the embodiments of the present disclosure, the feature value is calculated according to the data fragment by using a predefined feature value algorithm. For example, the MD5 algorithm may be used to calculate a data fragment to obtain the feature value of the data fragment. The size of a feature value is much smaller than the size of a data fragment. Therefore, comparing to transmitting a data fragment to the second node, when the first node transmits a feature value to the second node, much less resource is consumed, thereby achieving a higher transmission efficiency.

Optionally, when the data fragment is a data fragment that has not been previously transmitted, the first node transmits the data fragment to the second node, and also transmits the feature value of the data fragment to the second node. The second node caches the received data fragment and the feature value, so that when the first node needs to transmit the data fragment next time, only the feature value of the data fragment needs to be transmitted. The second node may obtain the data fragment from the local cache of the second node according to the feature value of the data fragment. In another optional implementation, when the data fragment is a data fragment that has not been previously transmitted, the first node transmits the data fragment to the second node. The second node receives the data fragment, obtains the feature value of the data fragment by using a predefined feature value algorithm, and caches the data fragment and the feature value of the data fragment. The above implementations may be flexibly configured in accordance with actual applications.

Optionally, when the data fragment is a data fragment that has not been previously transmitted, the first node further caches the data fragment and the feature value of the data fragment in the local cache of the first node. Based on the historically transmitted mail data, determining, by the first node, whether the data fragment is a data fragment that has been previously transmitted includes: acquiring the feature value of the data fragment; querying the local cache of the first node according to the feature value of the data fragment; when the feature value of the data fragment exists in the local cache, determining that the data fragment is a data fragment that has been previously transmitted; and when the feature value of the data fragment does not exist in the local cache, determining that the data fragment is a data fragment that has not been previously transmitted.

In the above-described solutions, when the data fragment is a data fragment that has not been previously transmitted, the first node stores the data fragment and the feature value of the data fragment in the local cache of the first node. Accordingly, the first node may determine whether the data fragment is a data fragment that has been previously transmitted by querying the local cache. Since the feature value may be directly calculated based on the data fragment and uniquely identify the data fragment, the first node may query the local cache using the feature value to determine whether the data fragment has been previously transmitted. Moreover, since the size of a feature value is much smaller than the size of a data fragment, by comparing the feature values, the processing speed of the first node may be greatly improved.

In S204, for a feature value, the second node may first acquire a data fragment corresponding to the feature value based on the feature value, and then merge a plurality of data fragments into the mail data.

Optionally, when the second node receives the data fragment and the feature value of the data fragment, the second node caches the data fragment and the feature value in correspondence. Optionally, when the second node only receives the data fragment, the second node obtains the feature value of the data fragment by using a predefined feature value algorithm, and then the second node respectively caches the data fragment and the feature value of the data fragment. When the second node only receives the feature value, the second node queries the local cache of the second node based on the feature value to acquire the data fragment corresponding to the feature value.

For any one data fragment, although the first node may have transmitted the data fragment, it may be not transmitted to the second node. Accordingly, after receiving a feature value, the second node may not find the corresponding data fragment in the local cache. Optionally, if the data fragment corresponding to the feature value exists in the local cache of the second node, the second node returns a hit response to the first node. Optionally, if the data fragment corresponding to the feature value does not exist in the local cache of the second node, the second node returns a miss response to the first node, where the miss response includes the feature value. The first node receives the miss response sent by the second node, determines the data fragment corresponding to the feature value based on the feature value included in the miss response, and transmits the data fragment corresponding to the feature value to the second node. The second node receives the data fragment and performs the subsequent process. Optionally, when returning the data fragment, the first node also returns the feature value of the data fragment, to allow the second node to identify and cache the data fragment.

After acquiring all the data fragments of the mail data, the second node combines the data fragments into the mail data. Optionally, the first node transmits a data fragment or the feature value of the data fragment to the second node by using a data packet. When the data fragment is a data fragment that has not been previously transmitted, a first data packet is transmitted to the second node, where the first data packet includes the data fragment, the feature value of the data fragment, and a fragment serial number of the data fragment. When the data fragment is a data fragment that has been previously transmitted, a second data packet is transmitted to the second node, where the second data packet includes the feature value of the data fragment and the fragment serial number of the data fragment. After receiving the second data packet, the second node first acquires the corresponding data fragment according to the feature value in the second data packet. After the data fragments are acquired based on the first data packets and the second data packets, the data fragments are combined into the mail data according to the fragment serial number in each data packet. For example, a data packet 1 includes a data fragment A, a feature value a of the data fragment A, and a fragment serial number x, and a data packet 2 includes a feature value b and a fragment serial number y. According to the feature value b, the second node acquires a data fragment B corresponding to the feature value b. The data fragment A and the data fragment B are combined into the mail data according to the fragment serial number x and the fragment serial number y, respectively.

To describe the mail transmission method provided by the embodiments of the present disclosure more specifically, some specific examples are provided hereinafter for illustration purpose.

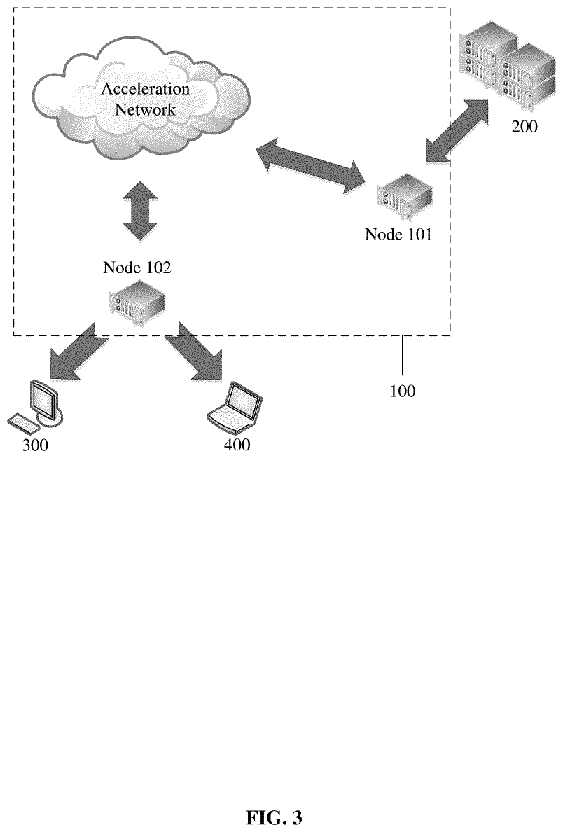

FIG. 3 is a schematic structural diagram of a practical mail transmission system according to some embodiments of the present disclosure. As shown in FIG. 3, the mail transmission system 100 is located between a mail server 200 and a user terminal 300/a user terminal 400. The mail transmission system 100 includes a node 101 and a node 102, where the node 101 is adjacent to the mail server 200, while the node 102 is adjacent to the user terminal 300 and the user terminal 400. It should be noted that, in the embodiments of the present disclosure, or in the existing technologies, a user terminal needs to send a mail request directly or indirectly to a mail server before receiving a mail. The mail request includes the information for a target mail to be received by the user terminal. After the mail server receives the mail request, the mail server will transmit the mail data directly or indirectly to the user terminal.

Based on the mail transmission system 100 shown in FIG. 3, in the embodiments of the present disclosure, the mail transmission method provided by the embodiments of the present disclosure is illustrated in conjunction with two frequently occurred situations with a high mail data repetition rate: group mailing and mail forwarding.

In Situation 1, the mail server 200 sends a mail 1 to the user terminal 300 and the user terminal 400 as a group mail.

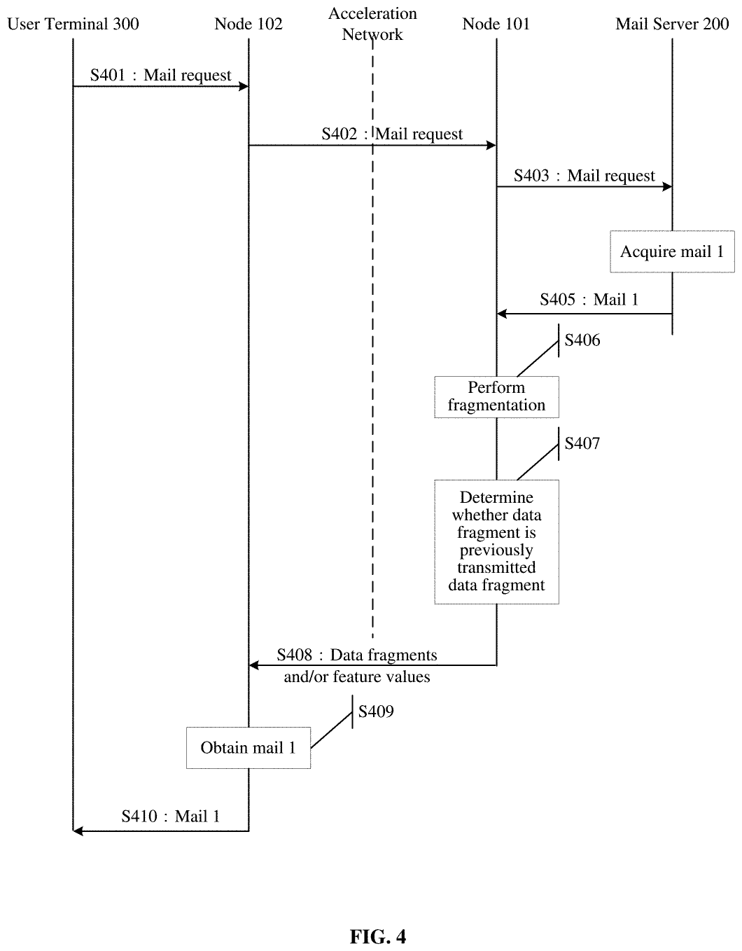

Taking the user terminal 300 as an example, in the process of sending the mail 1 to the user terminal 300 by the mail server 200, the mail server 200 is the transmitting terminal, while the user terminal 300 is the receiving terminal. Therefore, the node 101 is the first node, and the node 102 is the second node. FIG. 4 is a schematic diagram of a mail transmission process according to some embodiments of the present disclosure. As shown in FIG. 4, the method mainly includes the following steps:

S401: the user terminal 300 sends a mail request to the node 102.

The mail request includes an identifier for the mail 1.

S402: the node 102 sends the mail request to the node 101 through the acceleration network.

S403: the node 101 forwards the mail request to the mail server.

S404: the mail server acquires the mail 1 according to the identifier of the mail 1.

S405: the mail server transmits the mail 1 to the node 101.

S406: the node 101 performs a fragmentation process on the mail 1.

S407: the node 101 determines, according to the historically transmitted mail data, whether a data fragment is a data fragment that has been previously transmitted.

S408: the node 101 transmits data fragments and/or feature values of data fragments to the node 102 through the acceleration network.

S409: the node 102 obtains the mail 1 according to the data fragments and/or the feature values of the data fragments.

S410: the node 102 transmits the mail 1 to the user terminal 300.

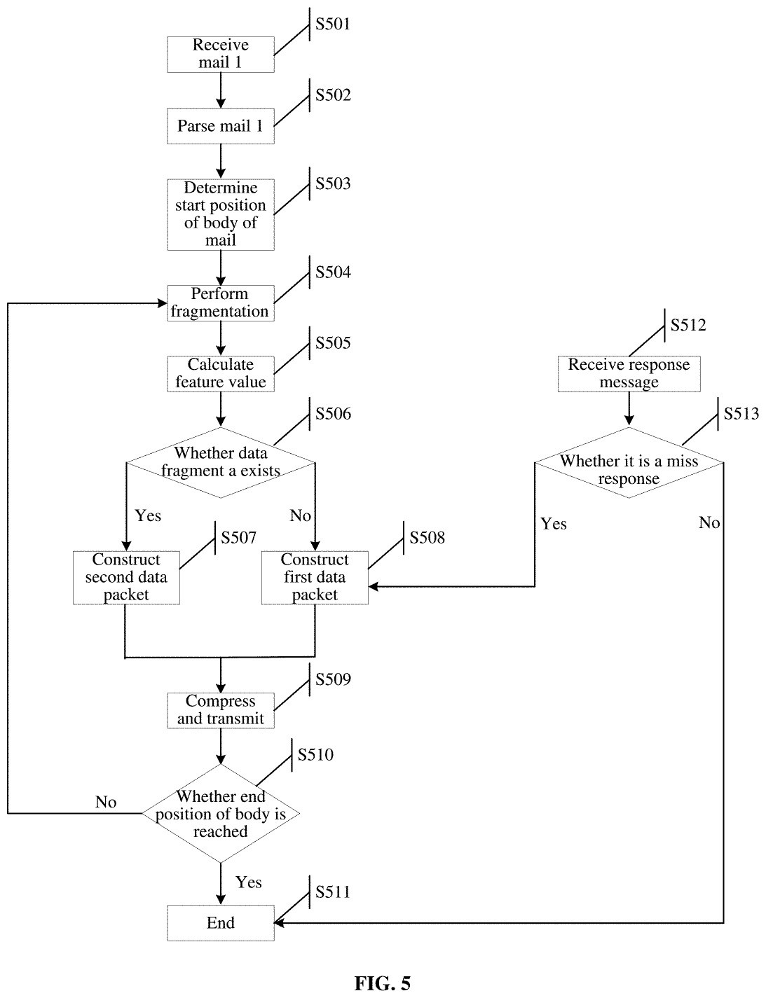

In the process shown in FIG. 4, the node 101 serves as the first node and specifically implements a process shown in FIG. 5. FIG. 5 is a schematic diagram of a practical mail transmission process by the first node according to some embodiments of the present disclosure, which corresponds to S406-S408 in FIG. 4, and specifically includes the following steps:

S501: receive the mail 1.

S502: parse the mail 1.

The parsing of the mail 1 mainly includes identifying the start position and the end position of the body of the mail 1.

S503: determine the start position of the body of the mail 1.

S504: perform a fragmentation process on the body of the mail 1 to obtain a data fragment a.

Here, the data fragment a does not specifically refer to a specific data fragment, but rather refers to a data fragment latest obtained when the mail 1 is fragmented.

S505: calculate a feature value of the data fragment a.

S506: query the local cache according to the feature value of the data fragment a. When the data fragment a exists in the local cache, proceed to S507. When the data fragment a does not exist in the local cache, proceed to S508.

S507: construct a second data packet.

The second data packet includes the feature value of the data fragment a and the fragment serial number of the data fragment a.

S508: construct a first data packet.

The first data packet includes the data fragment a, the feature value of the data fragment a, and the fragment serial number of the data fragment a.

S509: compress a data stream formed by the first data packet and/or the second data packet, and transmit the data stream.

S510: determine whether the fragmentation process reaches the end position of the body of the mail 1; if the fragmentation process reaches the end position of the body of the mail 1, proceed to S511; if the fragmentation process has not reached the end position of the body of the mail 1, return to S504, and continue to perform the fragmentation process on data that has not been fragmented.

S511: end.

S512: receive a response message returned by the node 102.

S513: determine whether the received response message is a miss response; if the received response message is a miss response, proceed to S508; if the received response message is not a miss response, proceed to S511.

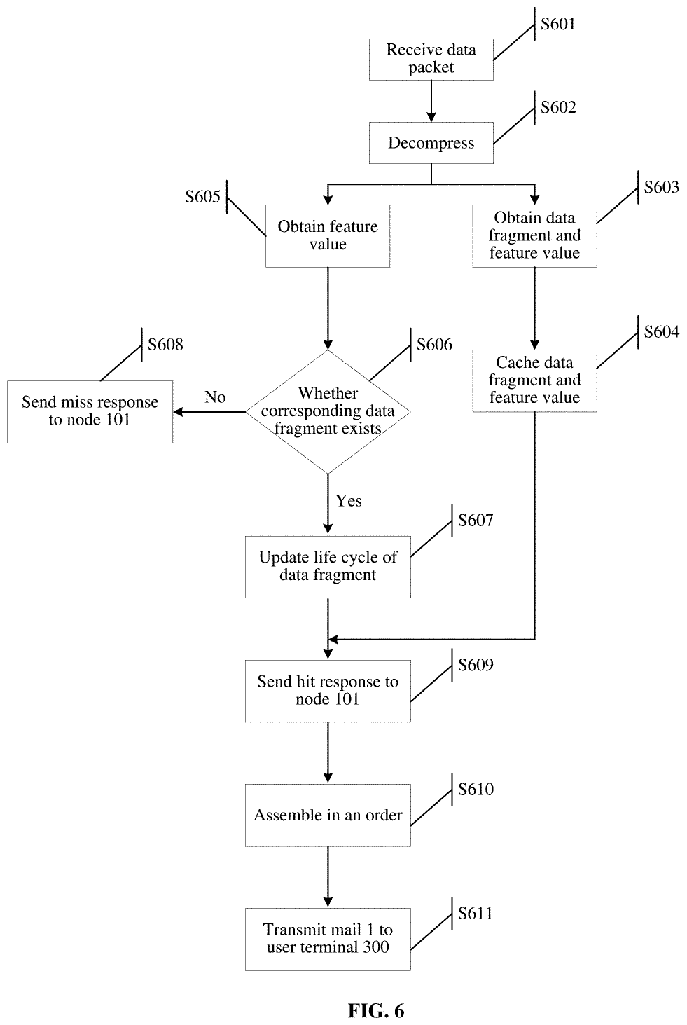

In the process shown in FIG. 4, the node 102 serves as the second node and specifically implements a process shown in FIG. 6. FIG. 6 is a schematic diagram of a practical mail transmission process by the second node according to some embodiments of the present disclosure, which corresponds to S409-S410 in FIG. 4, and specifically includes the following steps:

S601: receive a data packet.

S602: decompress the data packet.

S603: acquire the data fragment and the feature value of the data fragment in the data packet when the data packet is a first data packet.

S604: cache the data fragment and the feature value of the data fragment.

S605: acquire the feature value in the data packet when the data packet is a second data packet.

S606: query the local cache according to the feature value. When the corresponding data fragment exists in the local cache, proceed to S607. When the corresponding data fragment does not exist in the local cache, proceed to S608.

S607: update the life cycle of the data fragment in the local cache.

S608: send a miss response to the node 101.

S609: send a hit response to the node 101.

S610: combine the data fragments according to the fragment serial numbers, to obtain the mail 1.

S611: transmit the mail 1 to the user terminal 300.

Through the processes shown in FIGS. 4, 5, and 6, the mail 1 is received by the user terminal 300. Assume that the mail 1 is simultaneously sent to the user terminal 400 as a group mail. When the user terminal 300 receives the mail 1, the node 102 has cached all the data fragments of the mail 1. Then, when the node 101 transmits the mail 1 to the node 102, all the data fragments in the mail 1 are the data fragments that have been previously transmitted, so the node 101 only needs to transmit the feature values and the fragment serial numbers of the data fragments to the node 102. The node 102 may acquire the data fragments from the local cache of the node 102 according to the feature values of the data fragments, combine the data fragments into the mail 1 according to the fragment serial numbers, and then transmit the mail 1 to the user terminal 400.

Situation 2: the user terminal 300 forwards a mail to the user terminal 400.

Assume that the user terminal 300 has edited the mail 1 and generated a mail 2. The user terminal 300 needs to upload the mail 2 directly or indirectly to the mail server 200. The user terminal 400 then directly or indirectly sends a mail request to the mail server 200, to allow the mail server 200 to directly or indirectly transmit the mail 2 to the user terminal 400.

In the mail transmission system shown in FIG. 3, in the process in which the user terminal 300 uploads the mail 2 to the mail server 200, the user terminal 300 is the transmitting terminal, and the mail server 200 is the receiving terminal, so the node 102 is the first node, while the node 101 is the second node.

After receiving the mail 2 transmitted by the user terminal 300, the node 102 also performs a fragmentation process on the mail 2, and determines whether each data fragment is a data fragment that has been previously transmitted. Since the mail 2 is edited on the basis of the mail 1, most of the data fragments of the mail 2 are data fragments that have been previously transmitted, and only partial of the data fragments of the mail 2 are data fragments that have not been previously transmitted. For different data fragments, the node 102 adopts a processing procedure similar to FIG. 5, details of which will not be repeated in the embodiments of the present disclosure. Similarly, the node 101 also may adopt a process similar to FIG. 6 for the received data packets, details of which will also not be repeated in the embodiments of the present disclosure.

Based on the similar technical concept, the embodiments of the present disclosure further provide a node server, where the node server is applied to a mail transmission system including a first node and a second node, where the first node is configured to receive mail data transmitted by a transmitting terminal, and the second node is configured to transmit the mail data to a receiving terminal. The node server is coupled to the first node, and may implement a mail transmission method provided by any of the foregoing embodiments. FIG. 7 is a schematic structural diagram of a node server according to some embodiments of the present disclosure. As shown in FIG. 7, the node server 700 includes: a processing unit 701 and a transceiving unit 702.

The processing unit 701 is configured to perform a fragmentation process on the mail data to obtain a plurality of data fragments. For each data fragment, the processing unit: determines, based on historically transmitted mail data, whether the data fragment is a data fragment that has been previously transmitted; when the data fragment is a data fragment that has not been previously transmitted, transmits the data fragment to the second node by using the transceiving unit 702; and when the data fragment is a data fragment that has been previously transmitted, transmits a feature value of the data fragment to the second node by using the transceiving unit 702, where the feature value is used to instruct the second node to acquire the data fragment.

Optionally, the processing unit 701 is further configured to:

cache the data fragment and the feature value of the data fragment in the local cache of the first node; and

the processing unit 701 is specifically configured to:

obtain the feature value of the data fragment;

query the local cache of the first node according to the feature value of the data fragment;

when the feature value of the data fragment exists in the local cache, determine that the data fragment is a data fragment that has been previously transmitted; and

when the feature value of the data fragment does not exist in the local cache, determine that the data fragment is a data fragment that has not been previously transmitted.

Optionally, the processing unit 701 is further configured to:

parse the mail data and determine body data of the mail data; and

the processing unit 701 is specifically configured to:

perform a fragmentation process on the body data of the mail data.

Optionally, the transceiving unit 702 is further configured to:

receive a miss response sent by the second node, where the miss response is sent when the second node does not obtain the data fragment corresponding to the feature value from the local cache of the second node, and the miss response includes the feature value; and

the processing unit 701 is further configured to:

determine a data fragment corresponding to the feature value according to the feature value in the miss response, and transmit the data fragment corresponding to the feature value to the second node by using the transceiving unit 702.

Optionally, the processing unit 701 is specifically configured to:

transmit, by using the transceiving unit 702, a first data packet to the second node, where the first data packet includes the data fragment, the feature value of the data fragment, and the fragment serial number of the data fragment, where the fragment serial number is used to denote a sequential number of the data fragment corresponding to the fragment serial number in the mail data; and

transmit, by using the transceiving unit 702, a second data packet to the second node, where the second data packet includes the feature value of the data fragment and the fragment serial number of the data fragment.

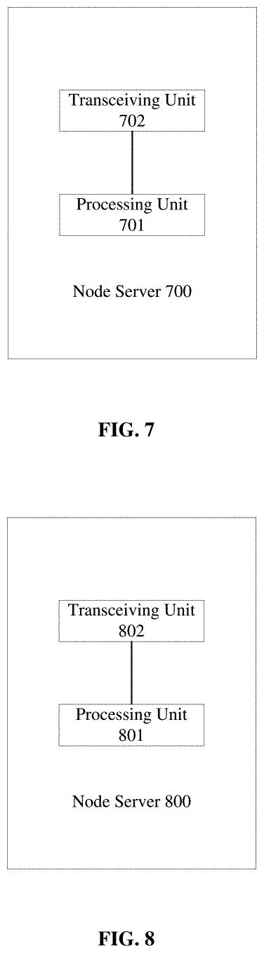

Based on the similar technical concept, the embodiments of the present disclosure further provide another node server, where the node server is applied to a mail transmission system including a first node and a second node, where the first node is configured to receive mail data transmitted by a transmitting terminal, and the second node is configured to transmit the mail data to a receiving terminal. The node server is coupled to the second node, and may implement a mail transmission method provided by any of the foregoing embodiments. FIG. 8 is a schematic structural diagram of a node server according to some embodiments of the present disclosure. As shown in FIG. 8, the node server 800 includes: a processing unit 801 and a transceiving unit 802.

The transceiving unit 802 is configured to receive a data fragment of the mail data transmitted by the first node; where the data fragment is transmitted after the first node performs a fragmentation process on the mail data and when it is determined, based on historically transmitted mail data, that the data fragment is a data fragment that has not been previously transmitted; and/or

receive a feature value of the data fragment of the mail data transmitted by the first node, where the feature value is transmitted after the first node performs the fragmentation process on the mail data and when it is determined, based on the historically transmitted mail data, that the data fragment is a data fragment that has been previously transmitted; and

the processing unit 801 is configured to generate the mail data based on each received data fragment and/or each received feature value, and transmit the generated mail data to the receiving terminal through the transceiving unit 802.

Optionally, the transceiving unit 802 is specifically configured to:

receive a first data packet transmitted by the first node, where the first data packet includes the data fragment and the feature value of the data fragment;

the processing unit 801 is specifically configured to:

store the data fragment and the feature value of the data fragment into a local cache of the second node; and

the processing unit 801 is further configured to:

query the local cache of the second node according to the feature value; and when the data fragment corresponding to the feature value exists in the local cache of the second node, acquire the data fragment.

Optionally, the processing unit 801 is further configured to:

when the data fragment corresponding to the feature value does not exist in the local cache of the second node, send a miss response to the first node, where the miss response includes the feature value, and the miss response is used to instruct the first node to transmit the feature value and the data fragment.

Optionally, the transceiving unit 802 is specifically configured to:

receive a second data packet transmitted by the first node, where the second data packet includes the feature value of the data fragment and a fragment serial number of the data fragment, the fragment serial number is used to denote a sequential number of the data fragment corresponding to the fragment serial number in the mail data, and the first data packet also includes the fragment serial number of the data fragment; and

the processing unit 801 is specifically configured to:

acquire each data fragment according to first data packets and/or second data packets, and combine each data fragment into the mail data according to fragment serial numbers.

Based on the similar technical concept, the embodiments of the present disclosure further provide a mail transmission system. The mail transmission system includes a node server provided by any of the foregoing embodiments, and may implement a mail transmission method provided by any of the foregoing embodiments.

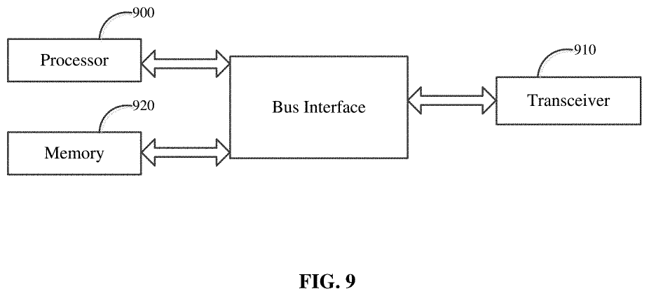

Based on the similar technical concept, the embodiments of the present disclosure provide a computing device. The computing device is a node server. FIG. 9 is a schematic structural diagram of a node server according to some embodiments of the present disclosure. The node server in FIG. 9 includes a processor 900 for reading programs stored in a memory 920 and implementing a mail transmission method provided by any of the foregoing embodiments.

In FIG. 9, the bus interface may include any number of interconnected buses and bridges, specifically linked by one or more processors represented by the processor 900 and various circuits of memory(ies) represented by the memory 920. The bus interface may also link various other circuits such as peripherals, voltage regulators, and power management circuits, as is well known in the art, and therefore, will not be further described herein. The bus interface provides interfaces. The transceiver 910 may include a plurality of components, such as a transmitter and a receiver, that provide means for communicating with various other devices on a transmission medium.

The processor 900 is responsible for managing the bus interface and the general processing, and the memory 920 may store data used by the processor 900 when performing operations.

Optionally, the processor 900 may be a CPU (Central Processing Unit), an ASIC (Application Specific Integrated Circuit), an FPGA (Field-Programmable Gate Array), or a CPLD (Complex Programmable Logic Device), etc.

Based on the similar technical concept, the embodiments of the present disclosure further provide a non-transitory computer-readable storage medium. The non-transitory computer-readable storage medium stores computer-executable instructions that are configured to cause a computing device to implement a mail transmission method in any of the foregoing embodiments.

The non-transitory computer-readable storage medium may be any available medium or data storage device accessible by a computer, including but not limited to magnetic storage (e.g., floppy disk, hard disk, magnetic tape, magneto-optical disk (MO), etc.), optical storage (e.g., CD, DVD, BD, HVD, etc.), and semiconductor memory (e.g., ROM, EPROM, EEPROM, NAND FLASH, SSD. etc.).

Although the preferred embodiments of the present disclosure have been described, once understanding the basic creative concept, a person skilled in the art may make other modifications and alterations to these embodiments. Therefore, the appended claims are intended to be interpreted as including the preferred embodiments and any modifications and alterations, all of which fall within the protection scope of the present disclosure.

It will be apparent that those skilled in the art may make various modifications and variations to the present disclosure without departing from the spirit and scope of the present disclosure. Therefore, if these modifications and variations to the present disclosure fall within the scope of the claims of the present disclosure or the similar techniques, the present disclosure is intended to cover such modifications and variations.

1. A mail transmission method for application in a mail transmission system including a first node and a second node, wherein the first node is configured to receive mail data transmitted by a transmitting terminal, and the second node is configured to transmit the mail data to a receiving terminal, the method comprising:
performing, by the first node, a fragmentation process on the mail data to obtain a plurality of data fragments; and
for each data fragment,
based on historically transmitted mail data, determining, by the first node, whether the data fragment is a data fragment that has been previously transmitted,
when the data fragment is a data fragment that has not been previously transmitted, transmitting, by the first node, the data fragment to the second node, and
when the data fragment is a data fragment that has been previously transmitted, transmitting, by the first node, a feature value of the data fragment to the second node, wherein the feature value is used to instruct the second node to acquire the data fragment.

2. The method according to claim 1, when the data fragment is a data fragment that has not been previously transmitted, the method further includes:
caching, by the first node, the data fragment and the feature value of the data fragment in a local cache of the first node; and
wherein determining, by the first node, based on the historically transmitted mail data, whether the data fragment is a data fragment that has been previously transmitted further includes:
acquiring the feature value of the data fragment,
querying the local cache of the first node according to the feature value of the data fragment,
when the feature value of the data fragment exists in the local cache of the first node, determining that the data fragment is a data fragment that has been previously transmitted, and
when the feature value of the data fragment does not exist in the local cache of the first node, determining that the data fragment is a data fragment that has not been previously transmitted.

3. The method according to claim 1, before performing, by the first node, the fragmentation process on the mail data, the method further includes:
parsing the mail data to determine body data of the mail data; and
wherein performing the fragmentation process on the mail data further includes:
performing the fragmentation process on the body data of the mail data.

4. The method according to claim 1, after transmitting the feature value of the data fragment to the second node, the method further includes:
receiving, by the first node, a miss response sent by the second node, wherein the miss response is sent to the first node by the second node when a data fragment corresponding to the feature value is not acquired from a local cache of the second node, and the miss response includes the feature value;
determining, by the first node, the data fragment corresponding to the feature value based on the feature value included in the miss response; and
transmitting, by the first node, the data fragment corresponding to the feature value to the second node.

5. The method according to claim 1, wherein:
transmitting the data fragment to the second node further includes:
transmitting a first data packet to the second node, wherein the first data packet includes the data fragment, the feature value of the data fragment, and a fragment serial number of the data fragment, the fragment serial number being used to denote a sequential number of a data fragment corresponding to the fragment serial number in the mail data; and
transmitting the feature value of the data fragment to the second node further includes:
transmitting a second data packet to the second node, wherein the second data packet includes the feature value of the data fragment and the fragment serial number of the data fragment.

6. A mail transmission method for application in a mail transmission system including a first node and a second node, wherein the first node is configured to receive mail data transmitted by a transmitting terminal, and the second node is configured to transmit the mail data to a receiving terminal, the method comprising:
receiving, by the second node, a data fragment of the mail data transmitted by the first node, wherein the data fragment is transmitted after the first node performs a fragmentation process on the mail data and when it is determined, based on historically transmitted mail data, that the data fragment is a data fragment that has not been previously transmitted; and/or
receiving, by the second node, a feature value of the data fragment of the mail data transmitted by the first node, wherein the feature value is transmitted after the first node performs the fragmentation process on the mail data and when it is determined, based on the historically transmitted mail data, that the data fragment is a data fragment that has been previously transmitted;
generating, by the second node, the mail data based on each received data fragment and/or each received feature value; and
transmitting, by the second node, the generated mail data to the receiving terminal.

7. The method according to claim 6, wherein receiving, by the second node, the data fragment of the mail data transmitted by the first node further includes:
receiving, by the second node, a first data packet transmitted by the first node, wherein the first data packet includes the data fragment and the feature value of the data fragment;
storing, by the second node, the data fragment and the feature value of the data fragment in a local cache of the second node; and
after receiving, by the second node, the feature value of the data fragment of the mail data transmitted by the first node, the method further includes:
querying, by the second node, the local cache of the second node based on the feature value, and
when a data fragment corresponding to the feature value exists in the local cache of the second node, acquiring, by the second node, the data fragment corresponding to the feature value.

8. The method according to claim 7, further comprising:
when the data fragment corresponding to the feature value does not exist in the local cache of the second node, sending, by the second node, a miss response to the first node, wherein the miss response includes the feature value, and the miss response is used to instruct the first node to transmit the feature value and the data fragment corresponding to the feature value to the second node.

9. The method according to claim 6, wherein receiving, by the second node, the feature value of the data fragment of the mail data transmitted by the first node further includes:
receiving, by the second node, a second data packet transmitted by the first node, wherein the second data packet includes the feature value of the data fragment and a fragment serial number of the data fragment, the fragment serial number being used to denote a sequential number of a data fragment corresponding to the fragment serial number in the mail data, and the fragment serial number of the data fragment being also included in the first data packet; and
wherein generating, by the second node, the mail data based on each received data fragment and/or each received feature value further includes:
acquiring, by the second node, each data fragment based on first data packets and/or second data packets, and
combining, by the second node, each data fragment into the mail data based on fragment serial numbers.

10. A node server for application in a mail transmission system including a first node and a second node, wherein the first node is configured to receive mail data transmitted by a transmitting terminal, the second node is configured to transmit the mail data to a receiving terminal, the node server is coupled to the first node, and the node server includes a processing unit and a transceiving unit, wherein:
the processing unit is configured to perform a fragmentation process on the mail data to obtain a plurality of data fragments, and for each data fragment: determine, based on historically transmitted mail data, whether the data fragment is a data fragment that has been previously transmitted, when the data fragment is a data fragment that has not been previously transmitted, transmit, through the transceiving unit, the data fragment to the second node, and when the data fragment is a data fragment that has been previously transmitted, transmit, through the transceiving unit, a feature value of the data fragment to the second node, wherein the feature value is used to instruct the second node to acquire the data fragment.

11. The node server according to claim 10, wherein the processing unit is further configured to:
cache the data fragment and the feature value of the data fragment in a local cache of the first node; and
the processing unit is configured to:
acquire the feature value of the data fragment,
query the local cache of the first node according to the feature value of the data fragment,
when the feature value of the data fragment exists in the local cache of the first node, determine that the data fragment is a data fragment that has been previously transmitted, and
when the feature value of the data fragment does not exist in the local cache of the first node, determine that the data fragment is a data fragment that has not been previously transmitted.

12. The node server according to claim 10, wherein the processing unit is further configured to:
parse the mail data to determine body data of the mail data; and
the processing unit is configured to:
perform the fragmentation process on the body data of the mail data.

13. The node server according to claim 10, wherein:
the transceiving unit is further configured to:
receive a miss response sent by the second node, wherein the miss response is sent by the second node when a data fragment corresponding to the feature value is not acquired from a local cache of the second node, and the miss response includes the feature value; and
the processing unit is further configured to:
determine the data fragment corresponding to the feature value based on the feature value included in the miss response, and transmit, through the transceiving unit, the data fragment corresponding to the feature value to the second node.

14. The node server according to claim 10, wherein the processing unit is further configured to:
transmit, through the transceiving unit, a first data packet to the second node, wherein the first data packet includes the data fragment, the feature value of the data fragment, and a fragment serial number of the data fragment, the fragment serial number being used to denote a sequential number of a data fragment corresponding to the fragment serial number in the mail data; and
transmit, through the transceiving unit, a second data packet to the second node, wherein the second data packet includes the feature value of the data fragment and the fragment serial number of the data fragment.

15. A node server for application in a mail transmission system including a first node and a second node, wherein the first node is configured to receive mail data transmitted by a transmitting terminal, the second node is configured to transmit the mail data to a receiving terminal, the node server is coupled to the second node, and the node server includes a processing unit and a transceiving unit, wherein:
the transceiving unit is configured to receive a data fragment of the mail data transmitted by the first node, wherein the data fragment is transmitted after the first node performs a fragmentation process on the mail data and when it is determined, based on historically transmitted mail data, that the data fragment is a data fragment that has not been previously transmitted; and/or
receive a feature value of the data fragment of the mail data transmitted by the first node, wherein the feature value is transmitted after the first node performs the fragmentation process on the mail data and when it is determined, based on the historically transmitted mail data, that the data fragment is a data fragment that has been previously transmitted; and
the processing unit is configured to generate the mail data based on each received data fragment and/or each received feature value, and transmit, through the transceiving unit, the generated mail data to the receiving terminal.

16. The node server according to claim 15, wherein:
the transceiving unit is configured to receive a first data packet transmitted by the first node, wherein the first data packet includes the data fragment and the feature value of the data fragment;
the processing unit is configured to store the data fragment and the feature value of the data fragment in a local cache of the second node; and
the processing unit is further configured to query the local cache of the second node based on the feature value, and when a data fragment corresponding to the feature value exists in the local cache of the second node, acquire the data fragment corresponding to the feature value.

17. The node server according to claim 16, wherein the processing unit is further configured to:
when the data fragment corresponding to the feature value does not exist in the local cache of the second node, send a miss response to the first node, wherein the miss response includes the feature value, and the miss response is used to instruct the first node to transmit the feature value and the data fragment corresponding to the feature value.

18. The node server according to claim 15, wherein:
the transceiving unit is further configured to:
receive a second data packet transmitted by the first node, wherein the second data packet includes the feature value of the data fragment and a fragment serial number of the data fragment, the fragment serial number being used to denote a sequential number of a data fragment corresponding to the fragment serial number in the mail data, and the fragment serial number of the data fragment being also included in the first data packet; and
the processing unit is further configured to:
acquire each data fragment based on first data packets and/or second data packets, and combine each data fragment into the mail data based on fragment serial numbers.

19.-21. (canceled)
